(19) United States
(12) Patent Application Publication
(10) Pub. No.: US 2008/0191509 A1
(43) Pub. Date: Aug. 14, 2008

(54) SUNSHADE

(76) Inventor: ROBERT MONAHAN, Norwell, MA (US)

Correspondence Address: LAW OFFICE OF MAI VU PARE, 9107 WILSHIRE BLVD. #450, BEVERLY HILLS, CA, 90210, US

(21) Appl. No.: 11/673,309

(22) Filed: Feb. 9, 2007

(51) Int. Cl. B60J 3/00

(52) U.S. Cl. 296/97.5

(57) ABSTRACT

The present invention relates to a sunshade intended for use in automotive vehicles. The invention has improved stability and the pliable nature of the material from which it is constructed allows for effective use of the sunshade in a wide range of vehicle window shapes and sizes. The present invention further comprises a holder that may be attached to the sunshade intended to hold beverages or snack items.

### 1. FIELD OF THE INVENTION

The invention relates to sunshades intended for use in automotive vehicles.

### 2. BACKGROUND OF THE INVENTION

Sunshades for automobiles are known in the art and typically comprise a planar piece of material, suspended across a vehicle window, which minimizes amounts of visible and/or ultra-violet light that can pass through said material. The shades may be secured to the window itself or an area adjacent to a window. They are generally used to protect drivers and/or passengers from excessive sun exposure and increase comfort levels in vehicles by minimizing exposure to direct sun rays. It is well recognized that excessive UV exposure is linked to skin cancer, and children have less natural protection against UV rays and are thus more sensitive to UV exposure. Because of this increased risk to young children, sunshades have become commonplace in vehicles of families with young children.

Shortcomings in prior art sunshades stem from the difficulty to secure and/or keep them in place on vehicle windows. Conventional suction cups which are typically used to secure prior art shades are often unreliable for keeping the shades in place for long periods of time. Users often find themselves repeatedly moistening the seals between the window and suction or increasing downward pressure on the suction cups to secure the suction, which usually only temporarily improves the hold.

Additionally, prior art sunshades are generally constructed from rigid or semi-rigid materials that do not accommodate a variety of window shapes and sizes. With the wide variety in sizes and dimensions of windows, prior art devices may not adequately cover a user's window and fail to provide sufficient protection.

Prior art sunshades which adhere to surfaces of windows through static exist. Plastic sheets are charged so that they have the ability to cling onto window surfaces without adhesive material which may provide improved hold to a window surface when compared to conventional suction cups. However, there are several shortcomings with these devices. First, they are not convenient for the user to quickly remove and re-install. As a result, users are generally forced to keep them installed for longer than needed. Second, they may lend an unsightly appearance to the user's vehicle, as air pockets form between the window and sunshade. Third, because the material is rigid and cannot be manipulated to hold various configurations, user's must cut the material to fit their particular window shape and size.

Finally, vehicles often lack cup holders or snack compartments that are easily accessible for side, back seat passengers. This is especially true for young children whose movements are confined to car seats. Prior art sunshades do not provide any means to hold beverages or snack compartments. The present invention provides a sunshade that includes a beverage or snack compartment that is attached to the sunshade. When fully assembled, the compartment is in easy reach to a child sitting on a side passenger seat.

The present invention overcomes problems of the prior art by teaching a sunshade that is constructed from a pliable, stretchable material that can be expanded to cover a range of window shapes and sizes. The present invention is securely fastened to a window by modified suction cups that enable the user to quickly and easily form a stronger seal then those made with conventional suction cups. The present invention further provides a beverage or snack compartment. The enhanced stability of the sunshade, due to the modified suction cups, allows for a user to place heavier items such as soda cans or bottles within the compartments.

### 3. SUMMARY OF THE INVENTION

The present invention teaches a sunshade device comprised of flexible, non-rigid material, with the material having the ability to be stretched to increase its area. The material can be expanded when stretched but is able to return to its original dimensions when tension is released. The composition of the material limits the amount of UV light that is able to pass through and may also limit the amount of visible light that is able to pass, to improve passenger comfort.

In addition, the present invention comprises modified suction cups which enable the sunshade to be releasably attached to a surface such as a window. The modified suction cups comprise means to increase the vacuum created between the suction cup and window, thereby increasing the force of the suction in which the sunshade can be attached to a window. The enhanced suction ability of the suction cups enables the user to stretch the sunshade device to its maximum area and accommodate a larger window.

The present invention further comprises a holder to hold beverages or snack containers. The increased stability of the sunshade allows the user to securely hold beverages in place, without fear of the entire apparatus collapsing from the vehicle window.

### 4. BRIEF DESCRIPTION OF DRAWINGS

FIG. 1 is a planar view of the present invention.

FIG. 2 is an exploded top perspective of the components of a modified suction cup for attachment to a vehicle window.

FIG. 3 shows a bottom exploded view of the components of the modified suction cup for attachment to a vehicle window.

FIG. 4 is a side planar view of the modified suction cup for attachment to a vehicle window.

### 5. DETAILED DESCRIPTION OF PREFERRED EMBODIMENT

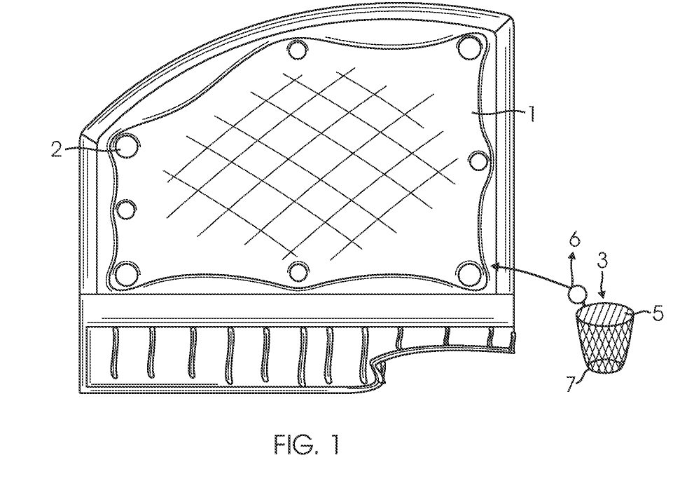

FIG. 1 shows the present invention in its intended use. The apparatus is comprised of a sunshade portion, 1 multiple modified suction cups 2, and a beverage/snack holder 3. The sunshade portion is constructed from pliable material that can be stretched to assume different dimensions. Suitable materials from which the sunshade may be constructed include spandex, lycra, nylon, spandex/polyester blends, and/or other synthetic materials. In the preferred embodiment of the present invention, the pliable material is made from 10% spandex and 90% polyester. The material may have a mesh configuration and contain openings that allow the passenger to see through the shade and look outside the vehicle, or visible light may be blocked out completely.

The material should have the ability to be easily stretched and increased in size, while returning to its original dimensions when not stretched. Once the material is expanded to its desired area, the user may secure the sunshade to a window through modified suction cups 2 positioned on the outer areas of the shade. The modified suction cups provide a stronger seal than conventional suction cups against a vehicle window. The mechanism of the modified suction cups is explained in further detail below.

Because the modified suction cups form a stronger seal with the window, a cup holder 3 or snack tray holder 3 may be attached and supported by the sunshade, allowing passengers a convenient location to hold beverages or snacks while traveling. The holder may releasably attach to the sunshade through attachment means such as snaps 6 or buttons. The holder may be comprised of a plastic or metal frame 5. Nylon, plastic, canvas or other easy to clean materials may be used to form a compartment 7 for holding drinks or snacks. The frame and compartment may be in a size that is suitable for holding drink containers and/or snacks. FIG. 1 shows one embodiment of the container holder.

Prior art sunshades are generally fastened to a user's window through the use of conventional suction cups. A conventional suction cup typically comprises of a unit with a concave body, constructed from material suitable for adhesion to a non-porous surface.

Prior art sunshades employing conventional suction cups frequently detach from vehicle windows because the vacuum of the suction cup is insufficient to prevent the gradual entry of air through the outer edges of the suction cup. As air continues to enter through the outer edges of the suction cup, the suction remains in position until air pressure outside equals the pressure within the suction cup. Prior art sunshades often come crashing down unexpectedly onto the passenger seat or floor of the vehicle. This problem can be irritating, especially when napping infants are disturbed by the disruption and sudden exposure to sun.

The present invention addresses this problem with the prior art by incorporating modified suction cups that increase the vacuum created between the suction cup and a vehicle window. It is well understood in the art the mechanism by which suction cups work. Negative pressure is created within a suction cup when it is pressed down upon a surface, expelling pressure from the suction cup, and then is allowed to return to its concave position. The pressure outside the suction cup is higher than the pressure within the suction cup and the resulting vacuum enables the suction cup to stick until the surrounding air pressure equals the air pressure within the suction cup. This happens through the gradual entry of air which penetrates the seal between the suction cup and the vehicle window.

It is also understood in the art that increasing the seal between the suction cup and applied surface can be achieved by pulling the center of the suction cup outwards. This further reduces the pressure within the suction cup, creating a stronger vacuum. The modified suction cups, which are known in the art, provide the user a means to pull the center of the suction cup outwards and hold the center in place. The modified suction cups of the present invention are comprised of the following components: a suction cup 20, a connection means 30, a peg unit 40, a base 50, a screw 60, a dial 70, and a cap 80. In a preferred embodiment, all of the components are constructed from plastic.

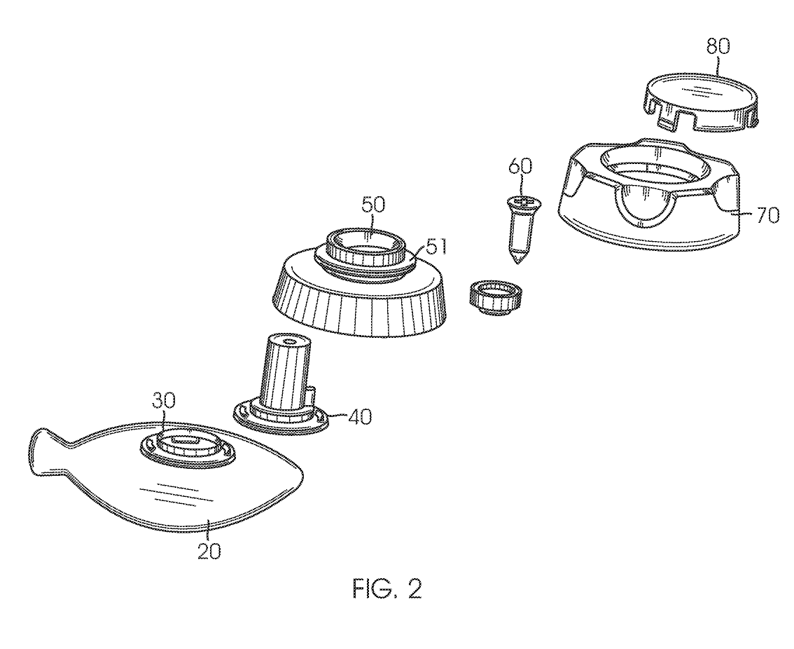

FIG. 2 shows an exploded top perspective of the components of the modified suction cup. The suction cup includes a connection means 30 that allows for the attachment of a peg unit 40 to the center of the suction cup. The peg unit is configured for insertion within a base 50. When the peg unit is inserted within the base, the base is configured to latch onto the peg unit so that movement of the base unit equals movement of the base. The top end of the base comprises a flanged cylinder 51 for interaction with a dial 70.

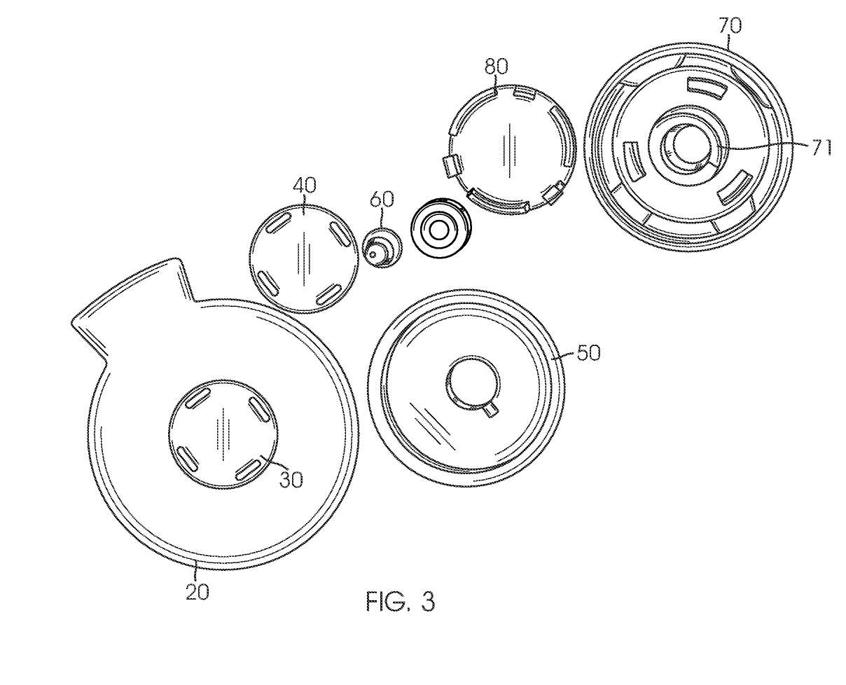

FIG. 3 shows an exploded bottom view of the components. A second flanged cylinder 71 is also present on the dial and can be seen in FIG. 3. When the dial is placed above the base, the flanged cylinders of the dial and base engage. When the dial is rotated, the interaction of the flanged cylinders of the dial and base result in movement of the peg unit that is perpendicular to the dial. This in turn results in an outward movement of the center area of the suction cup 20. The center area of the suction cup is held in this outward position by locking units within the dial. By holding the center of the suction cup in an outward direction, negative pressure formed between the suction cup and adhered surface is increased, forming a stronger seal than that formed with conventional suction cups.

Additionally, a cap 80 may be placed within the center of the dial for aesthetic purposes to hide the screw from view.

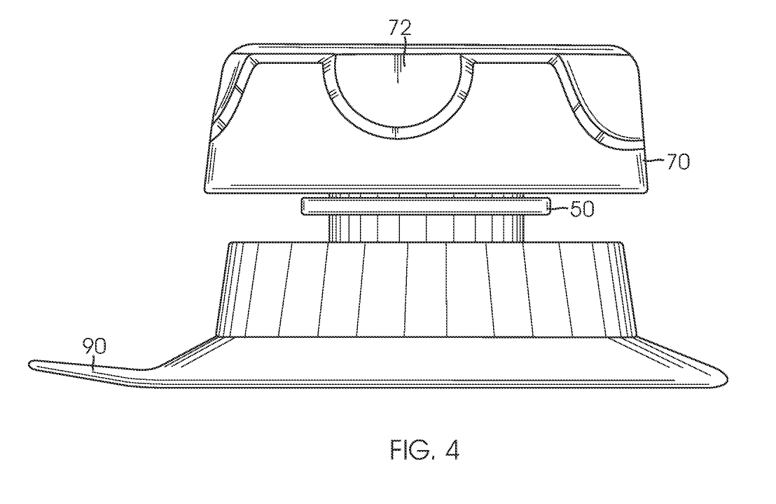

FIG. 4 shows a side view of the modified suction cup. The dial may comprise grooves 72 which allow for improved grasping by the user. The suction cup may further include a release tab 90. When the user wishes to easily release the suction cup from the vehicle window, the release tab may be pulled so that the seal between the suction cup and window surface is broken.

With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An apparatus for shading occupants of a vehicle comprising:
a sunshade portion;
said sunshade portion comprising a planar piece of pliable material capable of increasing or decreasing area when said pliable material is stretched or released; and
multiple, modified suction cups;
said suction cups comprising means to move and hold in position a center area of the suction cup in an outward direction, increasing the seal between the suction cup and a non-porous surface.

2. The apparatus of claim 1 further comprising a cup holder.

3. The apparatus of claim 1 further comprising a cup holder;
said cup holder comprises a frame and compartment.

4. The apparatus of claim 1 further comprising a snack holder.

5. The apparatus of claim 1 further comprising a snack holder;
said holder comprises a frame and compartment.

6. The apparatus of claim 1 wherein said pliable material consists of 10% spandex and 90% polyester.
